(19) United States
(12) Patent Application Publication
(10) Pub. No.: US 2007/0113572 A1
(43) Pub. Date: May 24, 2007

(54) AIR CONDITIONING UNIT

(75) Inventors: Wilhelm BARUSCHKE, Wangen (DE); Arthur Heberle, Mannheim (DE); Karl Lochmahr, Vaihingen/Enz (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/556,971

(22) Filed: Nov. 6, 2006

(30) Foreign Application Priority Data
Nov. 4, 2005 (DE) 10 2005 053 083.4

(51) Int. Cl. B60H 1/32; F25B 39/04

(52) U.S. Cl. 62/239; 62/508

(57) ABSTRACT

Air conditioning unit (1) suitable for stand-alone operation in a motor vehicle includes a refrigerant circuit (2) that has a compressor (3), a condenser (4) and an evaporator for cooling air which is to be conditioned, as well as at least one evaporator blower and a condenser fan (5) which can be driven by a motor (8). The motor (8) for the compressor (3) is arranged in an air duct (11), so that the motor (8) is actively ventilated with air in the air duct (11).

### CROSS-REFERENCE TO RELATED PATENT APPLICATIONS

The right of foreign priority is claimed under 35 U.S.C. § 119(a) based on Federal Republic of Germany Application No. 10 2005 053 083.4, filed Nov. 4, 2005, the entire contents of which, including the specification, drawings, claims and abstract, are incorporated herein by reference.

### BACKGROUND OF THE INVENTION

The invention relates to an air conditioning unit suitable for use in a motor vehicle, in particular for stand-alone operation during standstill (parking) periods.

It is an aim of vehicle manufacturers to provide a comfortable passenger compartment climate for vehicle occupants, even during standstill periods of a vehicle, in particular when the drive motor is switched off. For this purpose, standstill or parking air conditioning devices are increasingly provided, in particular in the field of commercial vehicles.

When outside temperatures are very high, a high level of comfort is important for a driver who spends the night, for example, in the sleeping cabin of a commercial vehicle. One problem during the standstill period is the supply of power, for example, for operating an air conditioning unit. As a result of the vehicle drive motor being switched off, as now required in many jurisdictions, the refrigerant compressor and required auxiliary units, such as various blowers or fans, must be supplied by an alternative power source.

Air conditioning systems are known which have a current-actuated compressor in the refrigerant circuit, in addition to the compressor actuated by the motor vehicle engine. The current-actuated compressor takes over the function of circulating the refrigerant in the standstill operating mode, and in this case the mode of operation is substantially the same as normal operation, except that another compressor takes over the function of circulating the refrigerant. In air conditioning systems of this type, at least two current-actuated blowers are provided, one for the air flow to be supplied to the vehicle passenger compartment, which is passed through the evaporator and is thereby cooled (fresh air or ambient air), and one for the air flow which cools the condenser (fresh air).

Stand-alone air conditioning units are also known which have a current-actuated refrigerant circulating arrangement and two current-actuated blowers, one for the air flow to be supplied to the vehicle passenger compartment, which is passed through the evaporator and is cooled (fresh air or ambient air), and one for the air flow which cools the condenser (fresh air). An air conditioning unit of this type still has room for improvement.

### SUMMARY OF THE INVENTION

It is therefore one object of the present invention to provide an improved air conditioning unit for stand-alone operation. A further object resides in providing a motor vehicle embodying such an improved air conditioning unit.

In accordance with one aspect of the present invention, there has been provided an air conditioning unit suitable for stand-alone operation in a motor vehicle, comprising: a refrigerant circuit including at least one compressor, at least one condenser and at least one evaporator for cooling air which is to be conditioned; a motor for driving the compressor; at least one evaporator blower and at least one condenser fan, and at least one air duct, wherein the motor for driving the compressor is arranged in the air duct so as to be actively ventilated with air flowing through said air duct.

In accordance with another aspect of the invention, there is provided a motor vehicle, comprising a passenger cab having a roof region, and an air conditioning unit according to invention mounted in said roof region.

Further objects, features and advantages of the present invention will become apparent from the detailed description of preferred embodiments that follows, when considered together with the accompanying figure of drawing.

### BRIEF DESCRIPTION OF THE DRAWINGS

The invention is explained in detail in the following description, with reference to a number of exemplary embodiments, including variants, and with reference to the drawings.

FIG. 1 is a schematic illustration of one preferred exemplary embodiment;

FIG. 2 is a schematic illustration of a typical air conditioning circuit; and

FIG. 3 is a schematic illustration of a typical overall system into which the present invention can be incorporated.

### DETAILED DESCRIPTION OF THE PREFERRED EMBODIMENTS

According to the invention, an air conditioning unit is provided that is suitable for stand-alone operation in a motor vehicle, the unit having at least one compressor which is used for circulating the refrigerant, which is arranged in the refrigerant circuit and which can be driven electrically. The air conditioning unit has at least one condenser and at least one evaporator for cooling air which is to be conditioned, as well as at least one evaporator blower and at least one condenser fan, both of which can be driven by a motor. The motor for the compressor is arranged in an air duct, such that the motor can be actively ventilated with air flowing in the air duct. This allows power-dependent cooling of the motor by means of the air flow, which preferably also flows through the condenser. As a result of advantages with regard to installation volume and weight, the air conditioning system can be of more compact design than corresponding conventional air conditioning systems.

Power electronics, which are assigned to the motor and/or the compressor, are also preferably arranged in the air duct, whereby it is also possible for the power electronics and/or the compressor to be cooled by the corresponding air flow.

The motor is preferably a brushless DC motor which is controlled by means of the associated power electronics. However, other types of drive motors are also possible. Here, in addition to the fan, which is particularly preferably directly attached to the motor shaft, the compressor is preferably also driven by the motor.

A mechanism, preferably a belt drive, is provided between the motor and the compressor, for transmitting the drive power of the motor to the compressor. Since the required air quantity for cooling the condenser, the motor and the power electronics correlates largely with the required compressor speed, this configuration allows a cost-effective and simple design for the standstill air conditioning system.

The fan preferably has at least two rotors, particularly preferably exactly two rotors, which are arranged on different shafts, with the shafts being coupled to one another by means of a mechanism, e.g., preferably a belt drive, and particularly preferably a belt drive that transmits the drive power from the motor to the compressor. Here, the rotors are in each case attached to the corresponding shafts, specifically the motor shaft and the compressor shaft.

As an alternative to mechanically coupled fans, it is also possible to use a fan arrangement having a plurality of separate fans which are not directly coupled to one another, yet for which one single controller can be provided.

As viewed in the air flow direction, the condenser, which is part of the refrigerant circuit, is preferably arranged in the air duct upstream of the at least one rotor (of the fan) and the motor, of the power electronics and of the compressor, so that an optimum degree of cooling power is available for the condenser, and yet the cooling power is still sufficient for the motor, the power electronics and the compressor.

The power electronics need not necessarily be arranged separately from the motor, but can instead also be integrated into the latter. For this purpose, corresponding measures are preferably provided to obtain sufficient cooling, such as, for example, cooling fins which project into the air duct.

The air conditioning unit can preferably be actuated or driven solely electrically (i.e., by means of a source of electrical power). The electrical power can be supplied via the normal on-board vehicle electrical system, from suitably powered auxiliary batteries and/or from a correspondingly rectified external power connection, e.g., shorepower or a generator.

The air conditioning unit is preferably arranged in the roof region of a motor vehicle, in particular of a commercial vehicle, such as an over-the road vehicle, typically a semi-trailer truck. Only a small number of other components are normally provided in the roof region, i.e., there is generally sufficient available installation space. Since only electrical lines for the power supply and for control must be guided to the air conditioning unit, there are no problems with regard to providing the power supply lines and the control system for the air conditioning unit.

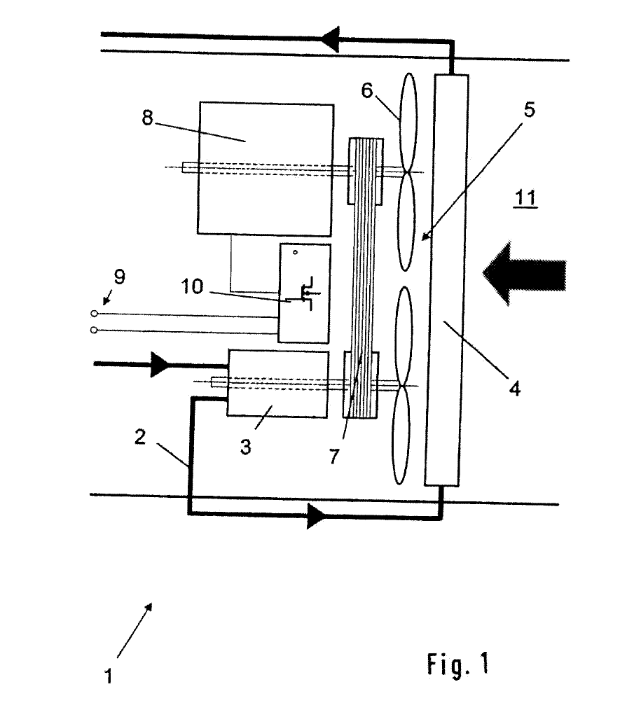

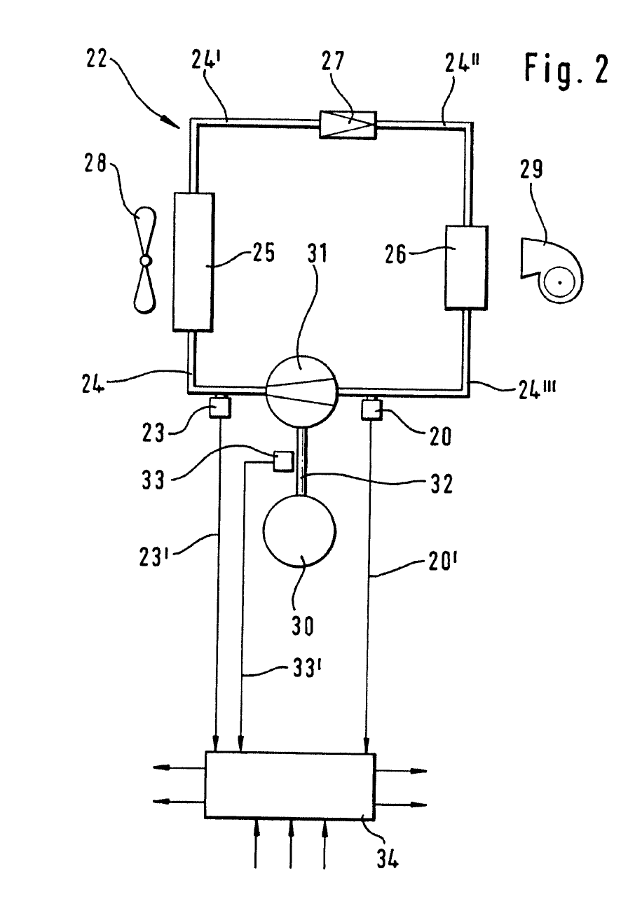

Turning now to the drawings, according to the exemplary embodiment described in more detail below, a stand-alone air conditioning unit 1 is provided in FIG. 1 which can be driven substantially independently of the motor vehicle engine and is therefore suitable for stand-alone operation, i.e., for operation when the motor vehicle engine is switched off. The unit 1 has a refrigerant circuit 2 that includes a compressor 3, an evaporator (see FIGS. 2 & 3) which serves to cool the air, and a condenser 4 which cools the refrigerant and is cooled by external air.

In addition, a blower is provided to feed the air, either ambient and/or fresh air, which is to be supplied to the vehicle passenger compartment. The blower is arranged in a first air duct and is driven by a blower motor (see FIGS. 2 & 3). A fan arrangement 5 is provided to feed the fresh air for cooling the condenser 4, whereby the fan arrangement 5 in this case preferably comprises two rotors 6, which are coupled to one another by means of a belt drive 7 and are driven by means of a motor 8. Here, one rotor 6 is attached to the motor shaft, and the other rotor 6 is attached to the compressor shaft, so that the rotors 6 in each case rotate at the corresponding shaft speed.

The motor 8 is in this case preferably a brushless DC motor that is supplied with direct current by the electrical power supply device 9, such as, for example, the on-board vehicle electrical system, or optionally with one or more auxiliary batteries and/or a correspondingly rectified external power connection. Of course, the motor 8 can alternatively be an AC motor, in which case the battery power will be converted to AC power. Suitable power electronics 10 are provided to control the motor 8 and any other electrical components.

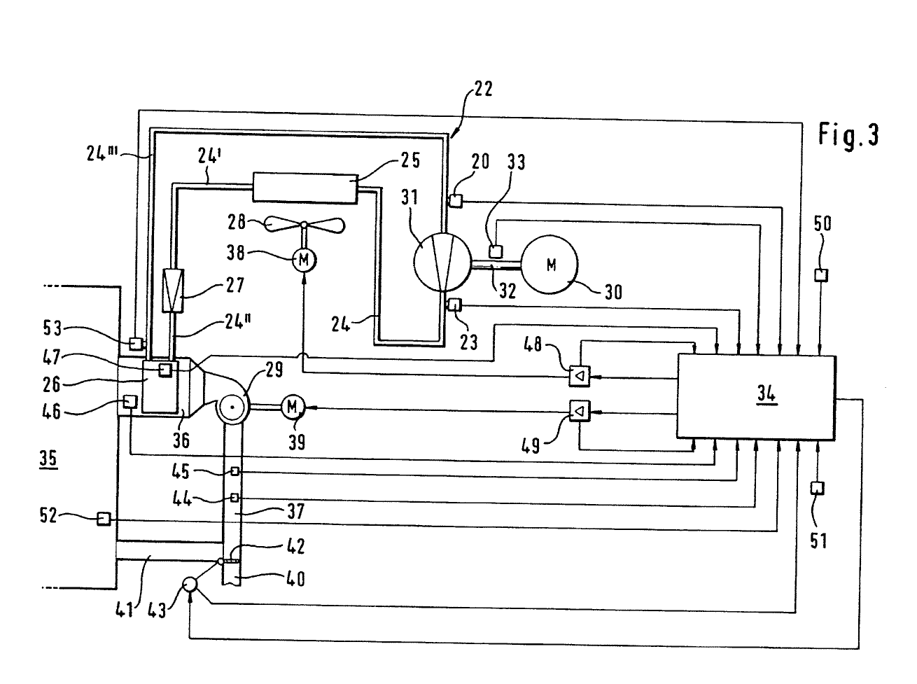

An exemplary overall cooling circuit into which the device of the invention can be integrated is schematically illustrated in FIGS. 2 and 3, which are taken from commonly assigned U.S. Pat. No. 6,073,457, the entire disclosure of which is hereby incorporated by reference. FIG. 2 shows a refrigerant circuit 22, which comprises a compressor 31, a condenser 25, an evaporator 26 and an expansion valve 27. The individual units 25, 26, 27, 31 are interconnected by means of pipelines 24, 24′, 24″, 24′″. The refrigerant circuit 22 is filled with a suitable refrigerant including, for example, an oil-containing refrigerant such as R134a, and the like. The condenser 25 is assigned a condenser blower 28, and an evaporator blower 29 is provided for generating an air flow through the evaporator 26. The compressor 31 is coupled to an drive member 30 by means of a drive shaft 32, drive member being, for example, an internal combustion engine driving a motor vehicle or, in the case of the present invention, an electric motor.

The sensors 20, 23, 33, the connected electronic control device 34 and the connecting lines 20′, 23′, 33′ shown in the figures are described in more detail in U.S. Pat. No. 6,073,457 and are not further discussed here, since they are not a necessary part of the present invention.

FIG. 3 depicts a refrigerant circuit 22 that corresponds in design to that described with reference to FIG. 2. Evaporator 26 is arranged in a supply air channel 36 for a passenger compartment 35 of a motor vehicle. Arranged upstream of the evaporator 26 in the air flow direction is the evaporator blower 29, which is connected on the suction side to an air guidance channel 37. Opening into the front end of the air guidance channel 37 is a fresh air channel 40 and a recirculating air channel 41, which can optionally be connected to the air guidance channel 37 by means of an air flap 42. The air flap 42, which is constructed as a fresh air/recirculating air flap, is coupled to a positioning motor 43, which is driven by the electric control device 34. The respective current position of the positioning motor 43 is detected and a corresponding signal is sent to the control device 34.

Further sensors 44, 45, 46, 47, 50, 52 and 53 are not described in more detail here, as not material to the present invention. Description can be found in the aforementioned patent.

As illustrated in FIG. 1, in a corresponding second air duct 11, which is formed so as to be separate from the previously mentioned first air duct, the air is guided past the condenser 4, through the rotors 6, past the belt drive 7 and past the compressor 3, the motor 8 and the power electronics 10, with the result that the compressor 3, the motor 8 and the power electronics 10 are actively cooled by the air flowing past. Since the required cooling air quantities of all three components 3, 8 and 10 are linked to one another, the air quantity required for cooling the three components 3, 8 and 10 can also be simultaneously ensured by setting the refrigeration power level by means of adjustments to the compressor speed.

Independent of the air conditioning system which takes over (or provides assistance with) the air conditioning function during normal operation of the vehicle, the air conditioning unit 1 is arranged in the roof region of a commercial vehicle. The control of the air conditioning unit 1, in particular of the compressor 3 and of the motor 8, is preferably carried out as a function of the cooling power demand. Measures may also be employed that help conserve the sometimes limited availability of the energy source, e.g., measures that take into consideration the power level supplied by the power source and/or charging state of the battery/batteries, such as a low power cut-off device.

According to one variant of the fourth exemplary embodiment, the power electronics are integrated directly into the motor, with the motor being designed so as to ensure that it and the integrated power electronics are cooled sufficiently by the air flowing past.

A second variant of the fourth exemplary embodiment provides that only one rotor is attached to the compressor shaft (or to the motor shaft or, if appropriate, is coupled to the compressor shaft or the motor shaft from another position via a power transfer mechanism). Alternatively, it is also possible to provide more than two rotors which are coupled to one another.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. Air conditioning unit suitable for stand-alone operation in a motor vehicle, comprising:
a refrigerant circuit including at least one compressor, at least one condenser and at least one evaporator for cooling air which is to be conditioned;
a motor for driving the compressor;
at least one evaporator blower and at least one condenser fan, and at least one air duct, wherein the motor for driving the compressor is arranged in the air duct so as to be actively ventilated with air flowing through said air duct.

2. An air conditioning unit according to claim 1, wherein the condenser is arranged in the air duct.

3. An air conditioning unit according to claim 1, further comprising power electronics arranged in the air duct, for controlling the motor.

4. An air conditioning unit according to claim 1, wherein the motor comprises a brushless DC motor.

5. An air conditioning unit according to claim 1, wherein the motor drives the fan and the compressor.

6. An air conditioning unit according to claim 5, wherein a drive mechanism couples the motor and the compressor.

7. An air conditioning unit according to claim 6, wherein the drive mechanism comprises belt drive.

8. An air conditioning unit according to claim 1, wherein the fan comprises at least two rotors which are arranged on different shafts, the shafts being coupled to one another by means of a drive mechanism.

9. An air conditioning unit according to claim 8, wherein the drive mechanism comprises a belt drive.

10. An air conditioning unit according to claim 8, wherein precisely two rotors are provided, one rotor being arranged on a shaft of the motor and one rotor being arranged on a shaft of the compressor.

11. An air conditioning unit according to claim 1, wherein, as viewed in the air flow direction, the condenser is arranged in the air duct upstream of the fan, the motor, the power electronics and the compressor.

12. An air conditioning unit according to claim 3, wherein the power electronics are integrated into the motor.

13. An air conditioning unit according to claim 1, wherein the air conditioning unit comprises mounting structure for mounting in the roof region of a motor vehicle.

14. A motor vehicle, comprising a passenger cab having a roof region, and an air conditioning unit as defined according to claim 1 mounted in said roof region.
